(19) United States
(12) Patent Application Publication
(10) Pub. No.: US 2011/0000547 A1
(43) Pub. Date: Jan. 6, 2011

(54) TUBULAR VALVING SYSTEM AND METHOD

(75) Inventor: Paul Joseph, Missouri City, TX (US)

Correspondence Address: CANTOR COLBURN LLP, 20 Church Street, 22nd Floor, Hartford, CT, 06103, US

(73) Assignee: BAKER HUGHES INCORPORATED, Houston, TX (US)

(21) Appl. No.: 12/497,083

(22) Filed: Jul. 2, 2009

(51) Int. Cl. F15D 1/02; F16K 15/02

(52) U.S. Cl. 137/1; 251/324

(57) ABSTRACT

A tubular valving system includes, a tubular having a bore therethrough with at least one port defining fluidic communication between the bore and an outside of the tubular, and a valve stem disposed within the bore of the tubular that is longitudinally movable with respect to the tubular, the valve stem has an outer surface slidably engagable with the bore, the outer surface has features that provide variably choked fluidic communication between the bore and the at least one port, and an amount of choke varies depending upon a relative position of the valve stem with respect to the bore

### CROSS REFERENCE TO RELATED APPLICATIONS

This application contains subject matter related to the subject matter of co-pending applications, which are assigned to the same assignee as this application, Baker Hughes Incorporated of Houston, Tex. The below listed applications are hereby incorporated by reference in their entirety:

U.S. Patent Application Attorney Docket No. 274-49265-US, entitled MODULAR VALVE BODY AND METHOD OF MAKING; and

U.S. Patent Application Attorney Docket No. 274-49267-US, entitled TUBULAR VALVE SYSTEM AND METHOD.

### BACKGROUND

Tubular valves that control occlusion of ports that fluidically connect a borehole of a tubular with an outside of the tubular are commonly used in several industries including the downhole completion industry. Such valves are deployed in boreholes to control fluid flow in both directions, inside to outside of the tubular as well as outside to inside of the tubular, through the ports. Needle valves with tapered seats and tapered plungers are commonly employed in applications where variable choking of the flow is desirable. The fit of the tapered plunger into the tapered seat, however, creates very tight clearances that are subject to jamming, preventing closure of the valve, by relatively small sized particles. In environments wherein contamination is prevalent, use of such valves can result in the inability to fully close the valve possibly necessitating removal, repair, cleaning or replacement of the valve. Costs associated with removal of the valve from the wellbore to repair or replace the valve, in addition to the cost of lost production while the well is not producing, are a few of the concerns associated with use of these valves. Systems and methods that overcome the foregoing concerns would be well received in the art.

### BRIEF DESCRIPTION

Disclosed herein is a tubular valving system. The system includes, a tubular having a bore therethrough with at least one port defining fluidic communication between the bore and an outside of the tubular, and a valve stem disposed within the bore of the tubular that is longitudinally movable with respect to the tubular, the valve stem has an outer surface slidably engagable with the bore, the outer surface has features that provide variably choked fluidic communication between the bore and the at least one port, and an amount of choke varies depending upon a relative position of the valve stem with respect to the bore.

Further disclosed herein is a method of choking a tubular valve. The method includes, slidably engaging a valve stem within a bore of a tubular between an open end of the tubular and at least one port fluidically connecting the bore to an outside of the tubular, and varying at least one of a flow path area or a flow path length between the bore and the at least one port by moving the valve stem relative to the tubular.

### BRIEF DESCRIPTION OF THE DRAWINGS

The following descriptions should not be considered limiting in any way. With reference to the accompanying drawings, like elements are numbered alike:

FIG. 1 depicts a cross sectional view of the tubular valving system disclosed herein in a fully open position;

FIG. 2 depicts a cross sectional view of the tubular valving system of FIG. 1 in a fully closed position;

FIG. 3 depicts a cross sectional view of the tubular valving system of FIG. 1 in a partially choked position;

FIG. 4 depicts a perspective view of a valve stem disclosed herein;

FIG. 5 depicts a perspective view of an alternate valve stem disclosed herein;

FIG. 6 depicts a perspective view of an alternate valve stem disclosed herein;

FIG. 7 depicts a perspective view of an alternate valve stem disclosed herein; and

FIG. 8 depicts a perspective view of yet another an alternate valve stem disclosed herein.

### DETAILED DESCRIPTION

A detailed description of one or more embodiments of the disclosed apparatus and method are presented herein by way of exemplification and not limitation with reference to the Figures.

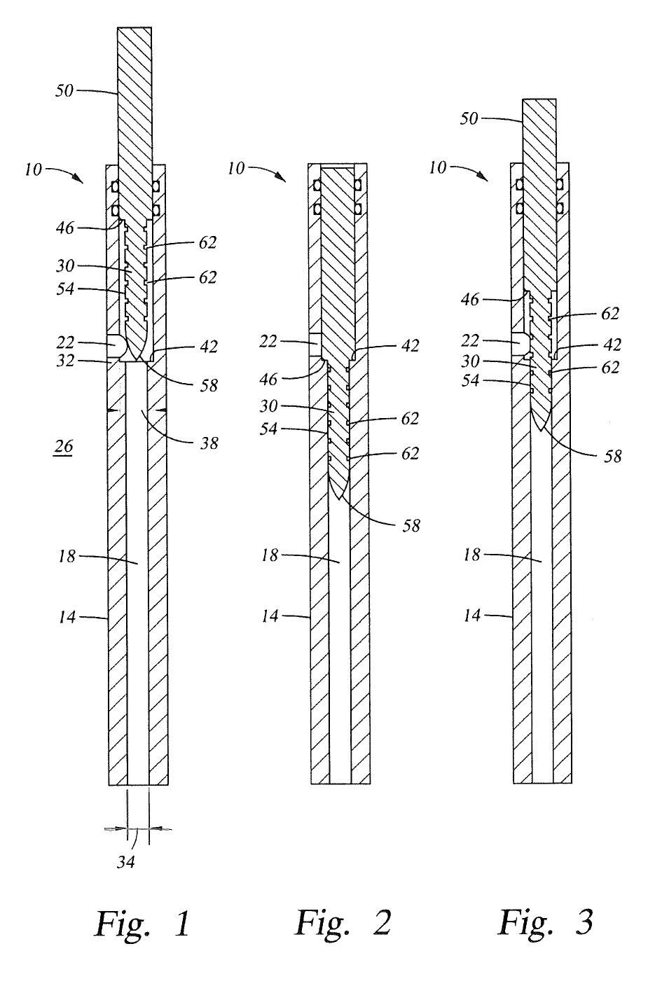

Referring to FIGS. 1-3, a tubular valving system is illustrated generally at 10. The valving system 10 includes, a tubular 14, having a bore 18 therethrough and a port 22 that fluidically connects the bore 18 to an outside 26 of the tubular 14, and a valve stem 30 slidably engaged with the bore 18. The valving system 10 is configured such that movement of the valve stem 30 in relation to the tubular 14 controls variable choking of flow between the bore 18 and the port 22.

The bore 18 has a step 32 defining a non-tapered smaller dimension 34 and a larger dimension 38, depicted in this embodiment as diameters, with a radial surface 42 located at the step 32. The port 22 fluidically connects the larger dimension 38 to the outside 26 of the tubular 14. Although the port 22 illustrated includes only a single opening, an embodiment having a port 22 with multiple openings is contemplated. The valve stem 30 includes a shoulder 46 that steps to a greater dimensioned portion 50 and a distal portion 54 with a nose cone 58 thereon. The valve stem 30 is longitudinally movable relative to the tubular 14 to a first position (illustrated in FIG. 2), defined by the shoulder 46 sealingly contacting the radial surface 42 thereby fully occluding or closing fluid communication between the bore 18 and the port 22, and a second position (illustrated in FIG. 1) defined by retraction of the valve stem 30 until the distal portion 54 is beyond the port 22 thereby fully opening fluid communication between the bore 18 and the port 22.

Referring to FIG. 3, the valve stem 30 is illustrated in a choke position between the fully open and the fully closed positions. In the choke position the valve stem 30 chokes fluid communication between the bore 18 and the port 22. This choking is due to a reduction in flow area defined between the valve stem 30 and the non-tapered smaller dimension 34 of the bore 18. The slidably engagable fit of a non-tapered outer dimension 60 of the distal portion 54 of the valve stem 30 within the non-tapered smaller dimension 34 of the bore 18 substantially forms a seal therebetween. A plurality of grooves 62 formed in the non-tapered outer dimension 66 of the valve stem 30 defines the flow area. The larger dimension portion 38 provides fluid communication between each of the grooves 62 open thereto and the port 22.

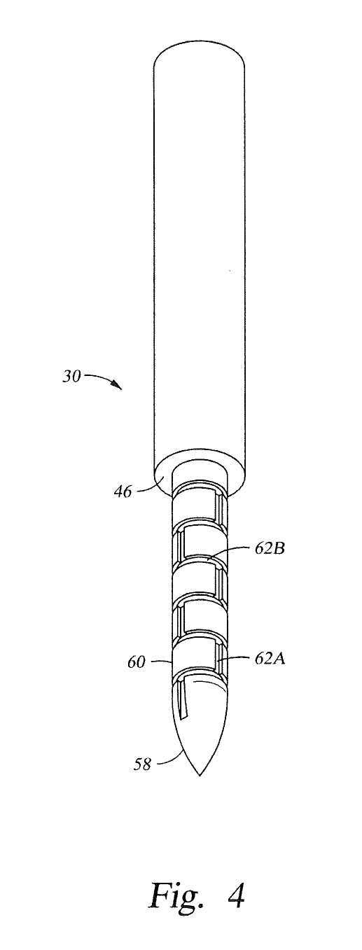

Referring to FIG. 4, the valve stem 30 is illustrated in a magnified perspective view. The grooves 62 include circumferential grooves 62A that are fluidically connected to longitudinal grooves 62B. At least one of the longitudinal grooves 62B extends beyond the non-tapered outer dimension 60 of the distal portion 54 and into the nose cone 58 thereby establishing a flow area between the non-tapered smaller dimension 34 and the non-tapered outer dimension 60 when the non-tapered dimension outer dimension 60 is slidably engaged with the non-tapered smaller dimension 34. This flow area is maintained through the grooves 62A and 62B to the larger dimension 38 and into the port 22. The further the non-tapered outer dimension 60 is engaged with the non-tapered smaller dimension 34 the longer the flow path is defined by the grooves 62A and 62B and the greater the resistance to fluid flow therethrough and the greater the choking of the flow. The dimensions and number of the grooves 62A and 62B can be selected to establish desired choke characteristics. For example, by increasing the number of circumferential grooves 62B in comparison to the number of longitudinal grooves 62A an operator can increase a length through which fluid must flow and increase the number of sharp turns the fluid must navigate during traverse from between the bore 18 and the port 22.

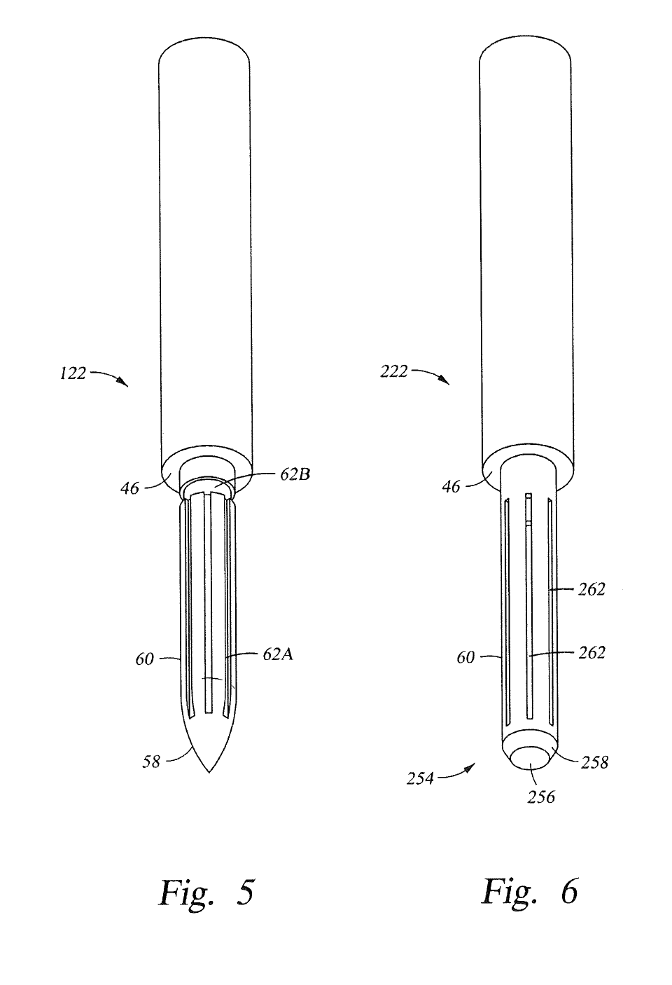

Referring to FIG. 5, an alternate embodiment of a valve stem 122 is illustrated with like elements from earlier figures numbered alike. The valve stem 122 includes longitudinal grooves 62A that extend from the nose cone 58 to near the shoulder 46. This embodiment presents a less tortuous flow path between the bore 18 and the port 22, than the valve stem 122.

Referring to FIG. 6, an alternate embodiment of a valve stem 222 is illustrated with like elements from earlier figures numbered alike. The valve stem 222 has a hollow distal portion 254 that has an inner bore 256 that extends all the way to a nose cone 258. A plurality of slots 262 fluidically connects the non-tapered outer dimension 60 to the inner bore 256. Since the slots 262 do not extend beyond the non-tapered outer dimension 60 area they do not fluidically connect directly with the non-tapered smaller dimension 34 of the bore 18 but only fluidically connect thereto through the inner bore 256. As such, all flow between the bore 18 and the port 22 needs to pass through the inner bore 256 and through at least one of the slots 262.

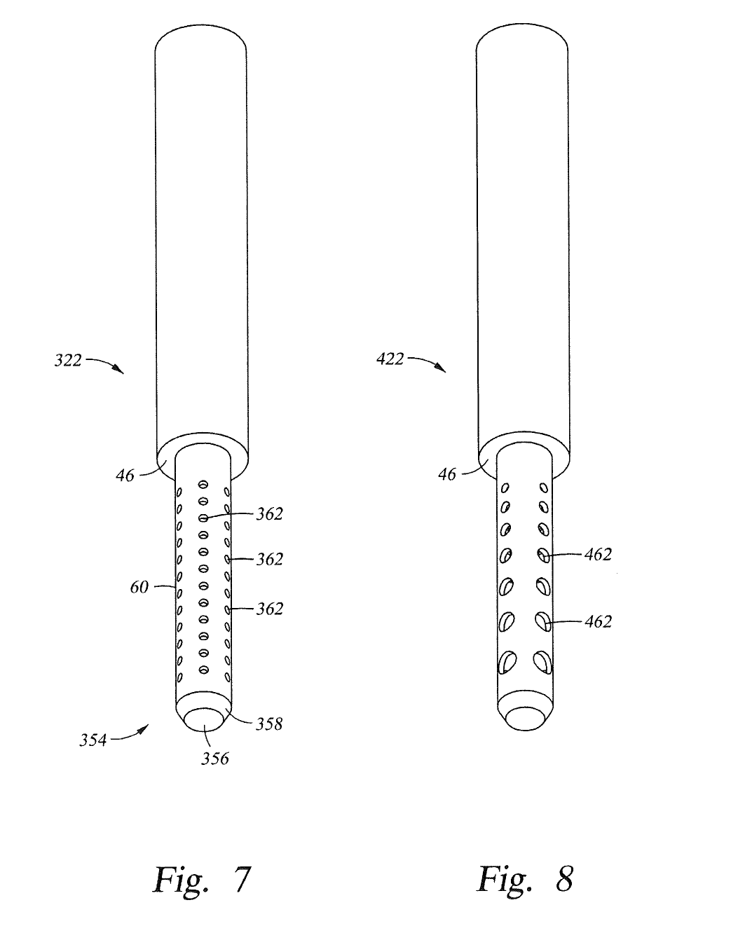

Referring to FIG. 7, an alternate embodiment of a valve stem 322 is illustrated with like elements from earlier figures numbered alike. The valve stem 322 has a hollow distal portion 354 that has a bore 356 that extends all the way to a nose cone 358. A plurality of ports 362 fluidically connects the non-tapered outer dimension 60 to the bore 356. As such, all flow between the bore 18 and the port 22 needs to pass through the bore 356 and through at least one of the ports 362.

Referring to FIG. 8, an alternate embodiment of a valve stem 422 is illustrated with like elements from earlier figures numbered alike. The valve stem 422 is similar to the valve stem 322 with the primary difference being that in the valve stem 422 a cross sectional area of a plurality of ports 462 varies in size. This size variation allows an operator greater control over the relationship between an amount of choke provided by the valving system 10 in relation to a positioning of the valve stem 422 within the non-tapered smaller dimension 34 of the bore 18. For example, by making the ports 462 nearer to the shoulder 46 smaller than the ports 462 further from the shoulder 46 (as is illustrated in this embodiment) for each additional incremental movement of the valve stem 422 in a more choking direction the amount of choking increases a greater amount than when the valve stem 422 previously moved the same incremental movement.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A tubular valving system, comprising:
a tubular having a bore therethrough with at least one port defining fluidic communication between the bore and an outside of the tubular; and
a valve stem disposed within the bore of the tubular being longitudinally movable with respect to the tubular, the valve stem having an outer surface slidably engagable with the bore, the outer surface having features that provide variably choked fluidic communication between the bore and the at least one port, and an amount of choke varies depending upon a relative position of the valve stem with respect to the bore.

2. The tubular valving system of claim 1, wherein the bore is non-tapered.

3. The tubular valving system of claim 1, wherein the valve stem is non-tapered.

4. The tubular valving system of claim 1, wherein the bore includes a dimensional step defining a larger dimensioned portion and a smaller dimensioned portion and the outer surface of the valve stem slidably engages with the smaller dimensioned portion.

5. The tubular valving system of claim 4, wherein the valve stem includes a shoulder sealably engagable with the dimensional step.

6. The tubular valving system of claim 1, wherein the valve stem and the tubular are configured to permit negligible flow between portions of the outer surface other than the features and the bore.

7. The tubular valving system of claim 1, wherein the features define flow paths between the bore and the at least one port.

8. The tubular valving system of claim 1, wherein the features include at least one perimetrical groove fluidically connected by at least one longitudinal groove.

9. The tubular valving system of claim 8, wherein the at least one perimetrical groove is a plurality of perimetrical grooves and the at least one longitudinal groove is a plurality of longitudinal grooves and a number of the plurality of perimetrical grooves is greater than a number of the plurality of longitudinal grooves.

10. The tubular valving system of claim 8, wherein at least one of the at least one longitudinal groove extends to a nose cone on the valve stem.

11. The tubular valving system of claim 1, wherein the valve stem includes an inner bore that is open at a distal end.

12. The tubular valving system of claim 11, wherein the features include at least one longitudinal slot that fluidically connects the inner bore with the outer surface.

13. The tubular valving system of claim 11, wherein the features include a plurality of ports that fluidically connect the inner bore with the outer surface.

14. The tubular valving system of claim 13, wherein the plurality of ports have circular cross sections.

15. The tubular valving system of claim 13, wherein a flow area of the plurality of ports varies.

16. The tubular valving system of claim 13, wherein at least one of the plurality of ports that is nearer to the distal end has a larger flow area than at least one port that is further from the distal end.

17. A method of choking a tubular valve, comprising:
slidably engaging a valve stem within a bore of a tubular between an open end of the tubular and at least one port fluidically connecting the bore to an outside of the tubular; and
varying at least one of a flow path area or a flow path length between the bore and the at least one port by moving the valve stem relative to the tubular.

18. The method of choking the tubular valve of claim 17, further comprising decreasing at least one of the flow path area and the flow path length between the bore and the at least one port by moving the valve stem toward the open end of the tubular.

19. The method of choking the tubular valve of claim 17, further comprising increasing at least one of the flow path area and the flow path length between the bore and the at least one port by moving the valve stem away from the open end of the tubular.

20. The method of choking the tubular valve of claim 17, further comprising sealingly engaging the valve stem with the tubular by moving a shoulder of the valve stem into sealing engagement with a stepped dimension of the bore between the open end and the at least one port.
